(19) United States
(12) Patent Application Publication
(10) Pub. No.: US 2019/0314773 A1
(43) Pub. Date: Oct. 17, 2019

(54) WATER CARBONATION INFUSION PUMPS

(71) Applicant: George M. Yui, Toronto (CA)

(72) Inventor: George M. Yui, Toronto (CA)

(21) Appl. No.: 15/953,463

(22) Filed: Apr. 15, 2018

(51) Int. Cl. B01F 3/04; B01F 15/06

(52) U.S. Cl. CPC B01F 3/04808; B01F 3/04751; B01F 2015/061; B01F 2003/049; B01F 15/065

(57) ABSTRACT

Devices for carbonating drinking water are disclosed. The devices include a container that is configured to hold a volume of carbonated drinking water; a CO₂ gas supply line that is configured to deliver CO₂ gas to the volume of carbonated drinking water within the container; and a variable speed electric motor located outside of and adjacent to an external surface of the container. In addition, the devices include a turbine type impeller that is magnetically coupled to and driven by the variable speed electric motor. The turbine type impeller is configured to rotate at variable speeds and spray carbonated drinking water transferred from a bottom portion of the container into an air space located above the volume of carbonated drinking water and the top internal surface of the container.

### FIELD OF THE INVENTION

The present invention relates generally to the field of water carbonators and carbonation infusion pumps and, more particularly, water carbonators and carbonation infusion pumps that may be used to produce carbonated (sparkling) drinking water.

### BACKGROUND OF THE INVENTION

The market for carbonated (sparkling) drinking water continues to grow at a rapid pace. It is well-documented that consumers are increasingly moving away from sugary beverages (including carbonated, artificially-flavored sodas), in favor of healthier drinking options (such as plain sparkling water). Most sparkling water beverages are sold to consumers in the form of pre-packaged drinks, such as individual cans or bottles holding consumable sparkling water. Only a few options exist that permit consumers to produce their own sparkling water at home, and such currently-available options have various drawbacks. Accordingly, there is a growing need for improved devices that enable consumers to produce, store, and dispense their own sparkling water at home, place of business, or other desired locations.

As the following will demonstrate, many of such needs are addressed by the carbonators and infusion pumps described herein.

### SUMMARY OF THE INVENTION

According to certain aspects of the invention, devices for carbonating drinking water are disclosed. The devices generally include a container that is configured to hold a volume of carbonated drinking water under pressure (preferably filled to about ¾ volume, leaving the top ¼ void with air space); a CO₂ gas supply line that is configured to deliver CO₂ gas to the volume of carbonated drinking water within the container; and a variable speed electric motor located outside of and adjacent to an external surface of the container (e.g., located on the top or bottom external side of the container). In addition, the devices include a turbine type impeller that is magnetically coupled to and driven by the variable speed electric motor. The turbine type impeller is configured to rotate at variable speeds and to spray carbonated drinking water transferred from a bottom portion of the container into the air space located above the volume of carbonated drinking water within the container. In addition to such devices for carbonating drinking water, the invention further encompasses devices for dispensing carbonated drinking water, which generally include the water carbonator described herein and one or more faucet actuators for dispensing the carbonated drinking water from the carbonator.

The above-mentioned and additional features of the present invention are further illustrated in the Detailed Description contained herein.

### BRIEF DESCRIPTION OF THE FIGURES

FIG. 1: A diagrammatic view of a carbonator of the present invention (which exhibits a recirculating pump positioned on the top side of the carbonator).

FIG. 2: A diagrammatic view of another carbonator of the present invention (which exhibits a recirculating pump positioned on the bottom side of the carbonator).

FIG. 3: A diagrammatic view of another carbonator of the present invention, which includes an internal evaporator.

FIG. 4: A diagrammatic view of a carbonator of the present invention, which further illustrates the location and configuration of the carbonator within the sparkling water dispenser systems described herein.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

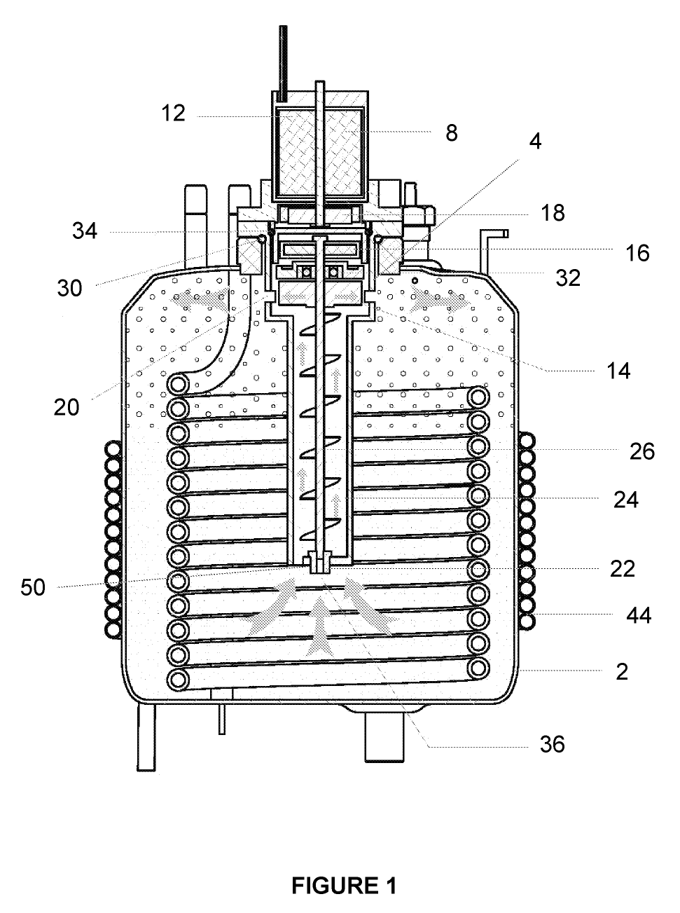

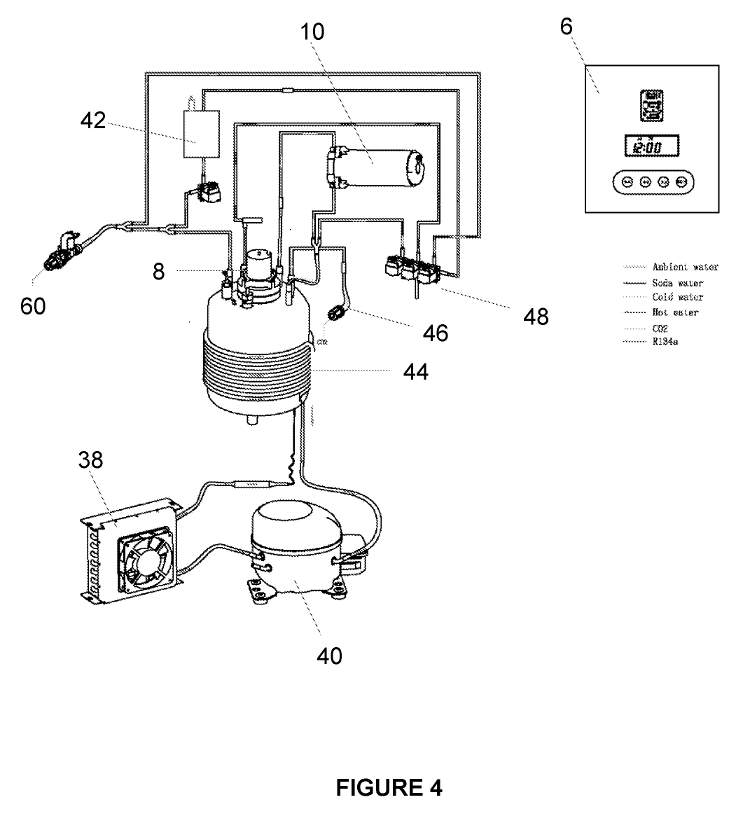

According to certain preferred embodiments of the present invention, a water carbonator is provided that includes an improved means for continuously carbonating and chilling dispensable drinking water. Referring now to FIGS. 1-4, the carbonator of the present invention includes a container 2 that is configured to hold a volume of carbonated drinking water. The carbonator further includes one or more sensors 4, which are configured to detect, monitor, and report the water level included in the container 2. The invention provides that the one or more sensors 4 will report the then-current water level to a central processing unit (CPU) 6. The CPU 6 is configured to communicate with a water booster pump 10 (FIG. 4 and discussed below), to either activate the booster pump 10 (to pump more water into the container 2 when the water level therein falls below a defined threshold) or deactivate the booster pump 10 (when the water level in the container 2 is above the defined threshold). The invention provides that the water level within the container 2 will preferably be maintained at about ¾ volume, with the remaining ¼ volume being used to pump CO₂ gas (and spray carbonated water) under pressure as described herein (with such pressure not to exceed 7 bars of pressure).

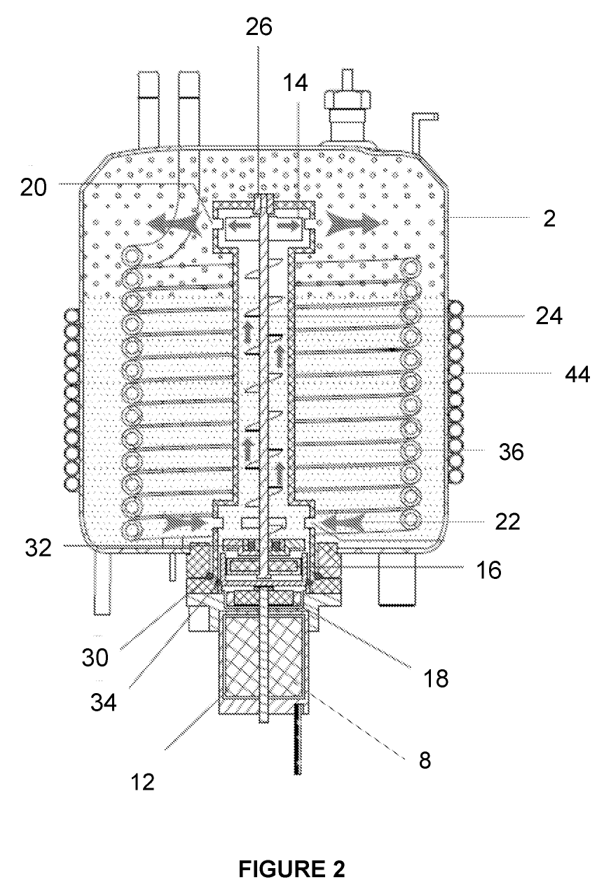

More specifically, according to certain preferred embodiments of the present invention, the carbonator includes a means for spraying the top, empty, internal air space of the container 2—i.e., above the water level in the container 2—with carbonated water. More particularly, the carbonator includes a recirculating pump 8, which is either mounted on top of the carbonator (FIG. 1) or on the bottom (FIG. 2). As mentioned above, the carbonator further includes (or is operably connected to) the booster pump 10 (FIG. 4), which is configured to supply pressure and pump water, from an external source, into the carbonator (when instructed to do so by the CPU 6). The invention provides that the external source of water may be a tap water line or a self-contained water bottle.

The invention provides that the recirculating pump 8 includes a variable speed electric motor 12, which is configured to produce the rotational force that ultimately rotates a turbine type impeller 14. More particularly, the variable speed electric motor 12 is operably connected to a magnetic slave clutch 16 and magnetic drive clutch 18 (FIGS. 1 and 2), which are configured to magnetically interact with and cause a turbine type impeller 14 to rotate. In other words, the magnetic slave clutch 16 and magnetic drive clutch 18 are configured to magnetically translate the rotational force generated by the external variable speed electric motor 12 to the turbine type impeller 14. The turbine type impeller 14 is preferably a rotating impeller that includes an internal channel and outlet window 20 through which carbonated water is recirculated and sprayed onto the top surface of a volume of carbonated water contained within the carbonator/container 2 (as mentioned above).

According to such embodiments, the carbonator further includes a circulation pump inlet 22, which is the portal through which carbonated water enters an impeller shaft 24 (from the volume of water within the container 2). The impeller shaft 24 receives water from inside of the carbonator/container 2 and channels the water up to and through the turbine type impeller 14. In addition, the impeller shaft 24, which is preferably cylindrical, houses a screw-shaped (auger-shaped) impeller blade 26 that rotates (in response to the rotational force generated by the variable speed electric motor 12). The rotation of the screw-shaped impeller blade 26 draws water through the circulation pump inlet 22 and up the impeller shaft 24, so that it will eventually be sprayed out of the outlet window 20 of the turbine type impeller 14 (and onto the top surface of water housed in the container 2).

The carbonator described herein may further include a series of seals and bearings. For example, the carbonator may include a seal 34 separating the variable speed electric motor 12 from the internal area of the carbonator/container 2 (which creates a sealed and water tight barrier between the motor 12 and the internal area of carbonator/container 2); a seal 30 (also configured to create a water-tight seal); a ball bearing 32 (which is configured to facilitate rotation of the turbine type impeller 14); and another bearing 50 (which is configured to facilitate rotation of the screw-shaped impeller blade 26). Still further, the carbonator may include a cooling coil 36 located inside of the carbonator/container 2, through which low-pressure water is circulated and cooled by the carbonated water included therein.

The invention provides that the carbonator described herein may be included within a drinking water dispensing system. In some embodiments, the source of water may be a water tap line (e.g., a water line of a home or building); whereas, in other embodiments, the source of water may be a self-contained bottle of water (e.g., a five gallon water bottle). In either case, the invention provides that—at the instruction of the CPU 6—water may be injected directly into the interior area of the container 2. In such embodiments, the drinking water dispensing system will be equipped with other customary components and features as well.

For example, and referring to FIG. 4, the drinking water dispensing system may include an internal power source (or plug through which power may be externally accessed); a cooling fan 38 (which is configured to generate flowing air and to cool down a condenser included within the system); a compressor 40 (which is configured to activate to provide the necessary pressure to force coolant to flow through a winding series of evaporator 44 tubes); an evaporator 44 that includes a series of tubes that surround and rest adjacent to the exterior surface of the container 2 through which coolant circulates (to chill the carbonated water housed within the container 2); an optional hot tank 42 that is configured to heat and store a volume of hot drinking water); a CO₂ gas supply line 46 (which is configured to connect to an external source of CO₂ gas and to transfer the CO₂ gas from the external source to the volume of water included in the container 2); dispenser actuators 48 that enable a user to selectively dispense cold, hot, and/or carbonated water from the system; and an ambient water dispenser actuator 60 that enables a user to selectively dispense ambient water from the system. Although the foregoing components are shown in a disassembled manner in FIG. 4 (for ease of reference), the invention provides that such components will preferably be securely housed and packaged within a rigid external housing.

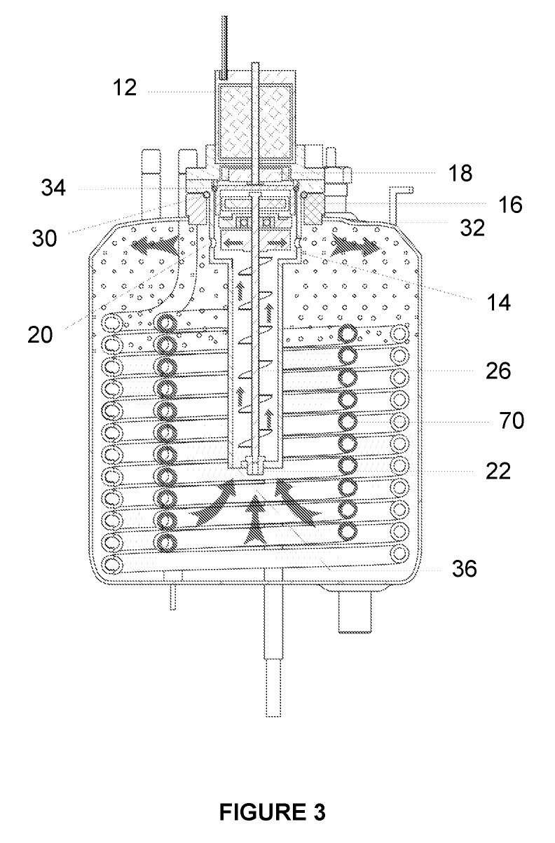

Referring now to FIG. 3, in certain embodiments, the invention provides that the carbonator may include an internal evaporator 70 (instead of an external evaporator 44). The invention provides that an internal evaporator 70 may be included when the recirculating pump 8 is mounted on top of the carbonator (FIGS. 1 and 3) or on the bottom (FIG. 2). As with the external evaporator 44, the internal evaporator 70 includes a series of tubes (within the container 2) through which coolant circulates to chill the carbonated water housed within the container 2.

According to yet further embodiments, the invention provides an improved ability to sanitize and disinfect the internal areas of the carbonator—using, for example, a customary cleaning solution, such as 2 PPM solution of chlorine. The invention provides that—during a sanitization process—the turbine type impeller 14 may be instructed (through the CPU 6) to rotate at relatively high speeds (e.g., 6000 RPM). In addition, the customary cleaning solution may be pumped into the internal area of the container 2, so that the turbine type impeller 14 then receives, sprays, and disperses the cleaning solution throughout the internal areas of the container 2, including the areas located above the typical water level (where contaminating bacteria may otherwise colonize).

The carbonator and recirculating pump 8 described herein have several important functionalities. For example, when the turbine type impeller 14 and impeller blade 26 are rotating at relatively low speeds, the assembly produces little or zero noise, but yet mixes the water contained therein to a homogeneous temperature (which allows the water to be maintained at a temperature just above freezing of 33.5-degrees Fahrenheit or 1-degree Celsius). Such lower temperatures also allow the water to have a higher CO₂ content/concentration. In addition, even when the water in the container 2 is desired to be heated or to be maintained at warm levels, the dispersion and recirculation of the carbonated water through the turbine type impeller 14 enables the water to have a higher CO₂ content. When the turbine type impeller 14 and impeller blade 26 are rotating at relatively higher speeds, the dispersion and recirculation of the carbonated water through the turbine type impeller 14 enables an improved mixing of CO₂ gas contained under pressure. The invention provides that the carbonator (and sparkling water dispensers) described herein are also particularly advantageous in that such devices are easier to “startup” than prior art devices. In addition, as described above, the carbonator (and sparkling water dispensers) described herein are easier to thoroughly clean and disinfect compared to prior art devices, particularly those internal areas located above the stored water level.

The many aspects and benefits of the invention are apparent from the detailed description, and thus, it is intended for the following claims to cover all such aspects and benefits of the invention, which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A device for carbonating drinking water, which comprises:
(a) a container that is configured to hold a volume of carbonated drinking water;
(b) a CO₂ gas supply line that is configured to deliver CO₂ gas from an external source of CO₂ gas to the volume of carbonated drinking water within the container;
(c) a variable speed electric motor located outside of and adjacent to an external surface of the container; and
(d) a turbine type impeller that is magnetically coupled to and driven by the variable speed electric motor, wherein the turbine type impeller is configured to rotate at variable speeds and to spray carbonated drinking water transferred from a bottom portion of the container into an air space located between the volume of carbonated drinking water and top internal surface of the container.

2. The device of claim 1, which further includes a cylindrical impeller shaft located within the container, which is configured to transfer carbonated drinking water from the bottom portion of the container and to the turbine type impeller.

3. The device of claim 2, wherein the cylindrical impeller shaft further houses a screw-shaped impeller blade that is coupled to and configured to rotate in response to the variable speed electric motor, wherein rotation of the screw-shaped impeller blade draws carbonated drinking water through the cylindrical impeller shaft and to the turbine type impeller.

4. The device of claim 3, which further includes an evaporator that is configured to chill the carbonated drinking water within the container.

5. The device of claim 4, wherein the variable speed electric motor is located adjacent to a top external surface of the container.

6. The device of claim 4, wherein the variable speed electric motor is located adjacent to a bottom external surface of the container.

7. The device of claim 4, wherein the evaporator surrounds and rests adjacent to an exterior surface of the container.

8. The device of claim 4, wherein the evaporator is located within the container.

9. A device for dispensing carbonated drinking water, wherein the device includes a water carbonator and one or more faucet actuators for dispensing said carbonated drinking water from the carbonator, wherein the carbonator comprises:
(a) a container that is configured to hold a volume of carbonated drinking water;
(b) a CO₂ gas supply line that is configured to deliver CO₂ gas from an external source of CO₂ gas to the volume of carbonated drinking water within the container;
(c) a variable speed electric motor located outside of and adjacent to an external surface of the container; and
(d) a turbine type impeller that is magnetically coupled to and driven by the variable speed electric motor, wherein the turbine type impeller is configured to rotate at variable speeds and to spray carbonated drinking water transferred from a bottom portion of the container into an air space located between the volume of carbonated drinking water and top internal surface of the container.

10. The device of claim 9, which further includes a cylindrical impeller shaft located within the container, which is configured to transfer carbonated drinking water from the bottom portion of the container and to the turbine type impeller.

11. The device of claim 10, wherein the cylindrical impeller shaft further houses a screw-shaped impeller blade that is coupled to and configured to rotate in response to the variable speed electric motor, wherein rotation of the screw-shaped impeller blade draws carbonated drinking water through the cylindrical impeller shaft and to the turbine type impeller.

12. The device of claim 11, which further includes an evaporator that is configured to chill the carbonated drinking water within the container.

13. The device of claim 12, wherein the variable speed electric motor is located adjacent to a top external surface of the container.

14. The device of claim 12, wherein the variable speed electric motor is located adjacent to a bottom external surface of the container.
